(19) United States
(12) Patent Application Publication
(10) Pub. No.: US 2025/0080252 A1
(43) Pub. Date: Mar. 6, 2025

(54) RRM BASED ON A WIDEBAND FREQUENCY MODULATED CONTINUOUS WAVE

(71) Applicant: QUALCOMM Incorporated, San Diego, CA (US)

(72) Inventors: Weimin DUAN, San Diego, CA (US); Kangqi LIU, San Diego, CA (US); Jing LEI, San Diego, CA (US); Tingfang JI, San Diego, CA (US)

(21) Appl. No.: 18/459,374

(22) Filed: Aug. 31, 2023

(51) Int. Cl. H04B 17/318; H04B 17/336; H04B 17/345

(52) U.S. Cl. CPC H04B 17/328; H04B 17/336; H04B 17/345

(57) ABSTRACT

A method for wireless communication at a user equipment (UE) and related apparatus are provided. In the method, the UE receives, from a network entity, a downlink wideband (DL WB) reference signal (RS) based on a frequency-modulated continuous wave (FMCW) signal; and report, based on the DL WB RS, a radio resource management (RRM) measurement. The RRM measurement may cover one or more sub-bands within one or more widebands of the FMCW signal.

### INTRODUCTION

The present disclosure relates generally to communication systems, and more particularly, to wireless communication including radio resource management (RRM).

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, an apparatus is provided for wireless communication at a user equipment (UE). The apparatus may include one or more memories and one or more processors coupled to the one or more memories. Based at least in part on information stored in the one or more memories, the one or more processors, individually or in any combination, are configured to cause the UE to receive a downlink wideband (DL WB) reference signal (RS) from a network entity based on a frequency-modulated continuous wave (FMCW) signal and report, based on the DL WB RS, a radio resource management (RRM) measurement that covers one or more sub-bands within one or more widebands of the FMCW signal.

In an aspect of the disclosure, an apparatus is provided for wireless communication at a UE. The apparatus includes means for receiving a DL WB RS from a network entity based on an FMCW signal and means for reporting, based on the DL WB RS, an RRM measurement that covers one or more sub-bands within one or more widebands of the FMCW signal.

In an aspect of the disclosure, a method is provided for wireless communication at a UE. The method includes receiving a DL WB RS from a network entity based on an FMCW signal and reporting, based on the DL WB RS, an RRM measurement that covers one or more sub-bands within one or more widebands of the FMCW signal.

In an aspect of the disclosure, a computer-readable storage medium (e.g., a non-transitory computer-readable storage medium) is provided for wireless communication at a UE. The computer-readable storage medium stores computer executable code at a UE, the code when executed by at least one processor causes the UE to receive a DL WB RS from a network entity based on an FMCW signal and report, based on the DL WB RS, an RRM measurement that covers one or more sub-bands within one or more widebands of the FMCW signal.

In an aspect of the disclosure, a method, an apparatus is provided for wireless communication at a network entity. The apparatus may include one or more memories and one or more processors coupled to the one or more memories. Based at least in part on information stored in the one or more memories, the one or more processors, individually or in any combination, are configured to cause the network entity to provide a DL WB RS based on a FMCW signal and obtain, based on the DL WB RS and covering one or more sub-bands within a wideband of the FMCW signal, an RRM measurement of a UE.

In an aspect of the disclosure, an apparatus is provided for wireless communication at a network entity. The apparatus includes means for providing a DL WB RS based on a FMCW signal and means for obtaining, based on the DL WB RS and covering one or more sub-bands within a wideband of the FMCW signal, an RRM measurement of a UE.

In an aspect of the disclosure, a method is provided for wireless communication at a network entity. The method includes providing a DL WB RS based on a FMCW signal and obtaining, based on the DL WB RS and covering one or more sub-bands within a wideband of the FMCW signal, an RRM measurement of a UE.

In an aspect of the disclosure, a computer-readable medium (e.g., non-transitory) is provided for wireless communication at a network entity. The computer-readable storage medium stores computer executable code at a network entity, the code when executed by one or more processors causes the network entity to provide a DL WB RS based on a FMCW signal and obtain, based on the DL WB RS and covering one or more sub-bands within a wideband of the FMCW signal, an RRM measurement of a UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2 is a diagram illustrating an example of a wireless communication system and an access network.

FIG. 3A is a diagram illustrating an example of a first frame, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second frame, in accordance with various aspects of the present disclosure.

FIG. 3D is a diagram illustrating an example of uplink (UL) channels within a subframe, in accordance with various aspects of the present disclosure.

FIG. 4 is a diagram illustrating an example of a base station and user equipment (UE) in an access network.

FIG. 5A is a diagram illustrating an example of orthogonal frequency division multiplexing (OFDM)-based channel estimation.

FIG. 5B is a diagram illustrating an example of frequency-modulated continuous wave (FMCW)-based channel estimation.

FIG. 6A is a diagram illustrating an example of identifying preferred sub-bands in FMCW-based channel estimation.

FIG. 6B is an example channel frequency response for various sub-bands of a wideband.

FIG. 7A is a diagram illustrating examples of wideband channel estimation.

FIG. 7B is a diagram illustrating examples of wideband channel estimation.

FIG. 8A is a diagram illustrating an example of an FMCW signal punctured in the frequency domain in accordance with various aspects of the present disclosure.

FIG. 8B is a diagram illustrating an example of a coordinated transmission of a wideband FMCW signal by multiple cells in accordance with various aspects of the present disclosure.

FIG. 9 is a call flow diagram illustrating a method of wireless communication in accordance with various aspects of the present disclosure.

FIG. 10 is a flowchart illustrating methods of wireless communication at a UE in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a network entity in accordance with various aspects of the present disclosure.

FIG. 13 is a flowchart illustrating methods of wireless communication at a network entity in accordance with various aspects of the present disclosure.

FIG. 14 is a diagram illustrating an example of a hardware implementation for an example apparatus and/or network entity.

FIG. 15 is a diagram illustrating an example of a hardware implementation for an example network entity.

### DETAILED DESCRIPTION

A frequency-modulated continuous wave (FMCW) signal, or an FMCW transmission, may include a continuous wave with a changing frequency. The frequency of the FMCW signal may be modulated or swept within a specific frequency range (e.g., ranging from a lower frequency to a higher frequency) in a continuous manner. To estimate the channel condition, a network may transmit a reference signal (RS) over the channel to a user equipment (UE), allowing the UE to perform measurements on the RS to assess the channel conditions. Example RSs may include the channel state information reference signal (CSI-RS), the sounding reference signal (SRS), and the demodulation reference signal (DM-RS), among others. The specific frequency range of an FMCW signal, which may be broader than the frequency band the UE operates within, may be referred to as the “wideband” of the FMCW signal. The frequency band in which the UE operates is referred to as the “narrowband.” A network may transmit an FMCW signal as a DL wideband (WB) channel sounding reference signal to a UE for various applications, including a wideband channel estimation. For example, an FMCW-based DL WB channel sounding reference signal may be used for channel estimation over a bandwidth wider than those the UE may support. For example, certain UE may not support communications over wider system bandwidths (e.g., the bandwidth over which the network, such as a base station, may use for transmitting a signal), such as frequency bandwidths ranging from 400 MHz up to 8 GHz for FR3, 6 GHZ, and sub-terahertz frequencies, among other examples. Some UEs (e.g., mid-tier UE and Internet of Things (IoT) devices, among other examples) may not fully support a full bandwidth spectrum of a wireless communication system, often being limited to the bandwidths of 20 MHz. 100 MHZ, 400 MHZ, or 1 GHz, among other examples. For such UE, the FMCW-based signal may be utilized for channel estimation. Wideband channel estimation enables the UE to scan a large bandwidth and identify one or more sub-bands for wireless communication. This scanning, which may be referred to as “large-scale” scanning as the UE is estimating channel information for a wideband using the narrow band processing capability, provides a comprehensive view of the available spectrum (e.g., system bandwidth), allowing the UE to select the suitable sub-bands for its specific use case and performance. In addition, from the network perspective, the configuration of resource efficiency may be similar to resources for UE-specific narrowband bandwidth part (NB BWP) allocations. Within the system bandwidth, there may be preferred sub-bands for communication with the UE and non-preferred sub-bands for communication with the UE, e.g., based on a channel quality experienced for the UE on the respective sub-bands. As presented herein, a UE may measure the FMCW-based reference signal to identify one or more sub-bands as being preferred and/or one or more sub-bands as being non-preferred for communication with the UE

Various UE may operate within different frequency ranges, and many of them may not support communication on a complete system bandwidth. As an example, a UE may not support communications on an ultra-wide system bandwidth that extends from 400 MHz to Frequency Range 3 (FR3), 6 GHZ, and sub-terahertz frequencies, among other examples. Some wireless communications may rely on narrowband measurements based on the type and range of bandwidth supported by the UE. For these communications, managing resource allocation over a wider system bandwidth based on the measurements on a narrowband (e.g., the frequency band the UE operates within, which may be narrower than the system bandwidth the network supports) can be time-consuming and may introduce additional signaling overhead. As a result, these methods struggle to effectively manage the resource allocation over the wider system bandwidth. Example aspects presented herein enhance radio resource management (RRM) for UE that operates within a bandwidth less than a system bandwidth. Example aspects presented herein provide a wideband reference signal (e.g., a reference signal spanning a frequency band wider than what the UE supports) based on an FMCW signal, which the UE can utilize for RRM measurements. The RRM measurements may refer to the measurements (e.g., channel estimation) performed to facilitate the allocation and utilization of available radio frequency (RF) resources, including time domain resources (e.g., symbols and slots) and frequency resources (e.g., frequency bands). The RRM measurements based on an FMCW signal may allow for UE-specific bandwidth part (BWP) selection enhancements. In some examples, by utilizing an FMCW-based DL WB RS, the described techniques enable the UE to scan and identify preferred sub-bands across a frequency band that exceeds the UE's supported bandwidth, accommodating the UE that may not support the entire bandwidth in which the network operates, thereby optimizing the usage of available bandwidth and improving the overall efficiency of wireless communication. The FMCW-based DL WB RS may be an RS signal derived from an FMCW signal that covers the wideband. For example, an FMCW-based DL WB RS may be an FMCW signal or a signal that has undergone digital or analog processing based on an FMCW signal. Since the FMCW signal spans a wider frequency bandwidth than what the UE supports, the UE may scan a larger bandwidth based on the FMCW signal and identify preferred sub-bands over a wider frequency band. In some aspects, the FMCW-based DL WB RS may be transmitted on an on-demand basis based on the UE's request. By offering an on-demand FMCW for additional measurements based on the specific operating conditions, such as communication associated with a specific cell or beam, the described techniques may be used to reduce the signaling overhead and power consumption associated with the RRM (e.g., by avoiding unnecessary FMCW transmissions through unrelated cells or beams). In some examples, the use of the FMCW-based DL WB RS enables the UE to perform the RRM measurements in less time, enabling power savings at the UE. For example, compared to the measurements that depend on frequency hopping, where the network may transmit multiple RSs to cover the wide system bandwidth, the RRM measurements based on the FMCW-based DL WB RS may be completed with fewer RS transmissions, resulting in reduced power consumption. Furthermore, due to the broader frequency coverage of the FMCW signal, a network may configure RRM measurements at longer intervals, which helps to reduce system overhead.

In some aspects, the UE may perform a one-shot wideband carrier RRM measurement on the FMCW reference signal. A “one-shot’ RRM measurement may refer to a channel estimation based on a single measurement instance. For example, the UE may estimate a channel over a system bandwidth based on a single measurement of the wideband FMCW reference signal using a narrowband processing (e.g., processing capability within the frequency band where the UE operates). The UE may extract the wider bandwidth channel information from the narrowband measurement of the FMCW signal.

In some aspects, the network may configure the UE to measure the wideband FMCW reference signal and other reference signals, such as SSB. In some aspects, the UE may request the network to transmit the wideband FMCW reference signal for additional measurements by the UE. For example, the UE may send a request for a wideband FMCW reference signal for a particular cell or beam, or at a particular periodicity. In some aspects, the network may configure the UE to measure the wideband FMCW reference signal based on an occurrence of a condition or event. In such examples, until the condition or event occurs, the UE may measure other reference signals, such as the SSB. In some aspects, the wideband FMCW signal may be punctured in frequency with other downlink signals. In some aspects, a wideband may be segmented into multiple sub-bands (e.g., smaller segments or portions of the wideband), and each sub-band may be used for an FMCW reference signal from a different cell.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

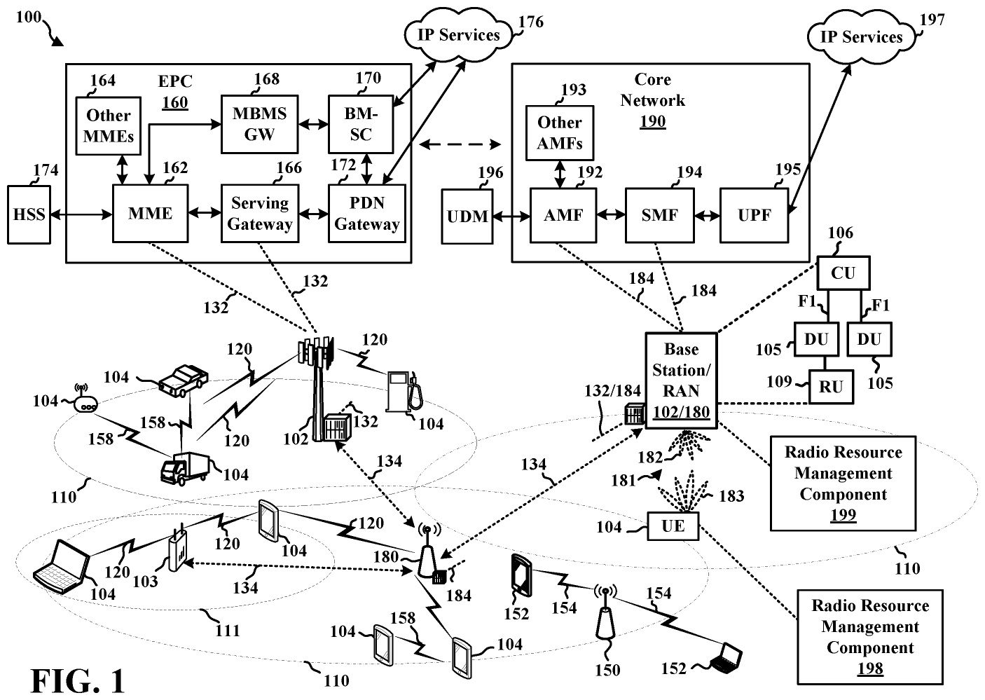

FIG. 1 is a diagram illustrating an example of a wireless communications system and an access network 100. The wireless communications system (also referred to as a wireless wide area network (WWAN)) includes base stations 102, UE 104, an Evolved Packet Core (e.g., an EPC 160), and another core network 190 (e.g., a 5G Core (5GC)). The base stations 102 may include macrocells (high power cellular base station) and/or small cells (low power cellular base station). The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UE 104. Each of the base stations 102 may provide communication coverage for a respective geographic coverage area 110. There may be overlapping geographic coverage areas. For example, a small cell 103 may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UE 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UE 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UE may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE), Wi-Fi based on the IEEE 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 103 may operate in a licensed and/or an unlicensed frequency spectrum. When operating in an unlicensed frequency spectrum, the small cell 103 may employ NR and use the same unlicensed frequency spectrum (e.g., 5 GHZ, or the like) as used by the AP 150. The small cell 103, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell 103 or a large cell (e.g., a macro base station), may include and/or be referred to as an eNB, gNodeB (gNB), or another type of base station. Some base stations, such as a gNB, may operate in a traditional sub 6 GHZ spectrum, in millimeter wave frequencies, and/or near millimeter wave frequencies in communication with the UE 104. When the gNB operates in millimeter wave or near millimeter wave frequencies, the base stations 180 may be referred to as a millimeter wave base station. A millimeter wave base station may utilize beamforming 181 with the UE 104 to compensate for the path loss and short range. The base stations 180 and the UE 104 may each include a plurality of antennas, such as antenna elements, antenna panels, and/or antenna arrays to facilitate the beamforming.

The base stations 180 may transmit a beamformed signal to the UE 104 in one or more transmit directions 182. The UE 104 may receive the beamformed signal from the base stations 180 in one or more receive directions 183. The UE 104 may also transmit a beamformed signal to the base stations 180 in one or more transmit directions. The base stations 180 may receive the beamformed signal from the UE 104 in one or more receive directions. The base stations 180/UE 104 may perform beam training to determine the best receive and transmit directions for each of the base stations 180/UE 104. The transmit and receive directions for the base stations 180 may or may not be the same. The transmit and receive directions for the UE 104 may or may not be the same.

The EPC 160 may include a Mobility Management Entity (e.g., an MME 162), other MMEs 164, a Serving Gateway 166, a Multimedia Broadcast Multicast Service (MBMS) Gateway (e.g., a MBMS Gateway 168), a Broadcast Multicast Service Center (BM-SC) (e.g., a BM-SC 170), and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UE 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UE 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The base stations 102 provide an access point to the EPC 160 or core network 190 for the UE 104.

Examples of UE include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UE may be referred to as IoT devices (e.g., parking meter, gas pump, toaster, vehicles, heart monitor, etc.). The UE may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a radio resource management component 198. The radio resource management component 198 may be configured to receive, from a network entity, a DL WB RS based on an FMCW signal; and report, based on the DL WB RS, an RRM measurement that covers one or more sub-bands within one or more widebands of the FMCW signal. In certain aspects, the base station 102 may include a radio resource management component 199. The radio resource management component 199 may be configured to provide a DL WB RS based on an FMCW signal; and obtain, based on the DL WB RS, an RRM measurement of a UE, where the RRM measurement covers one or more sub-bands within a wideband of the FMCW signal. Although the following description may be focused on 5G NR, the concepts described herein may be applicable to other similar areas, such as LTE, LTE-A, CDMA, GSM, and other wireless technologies.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

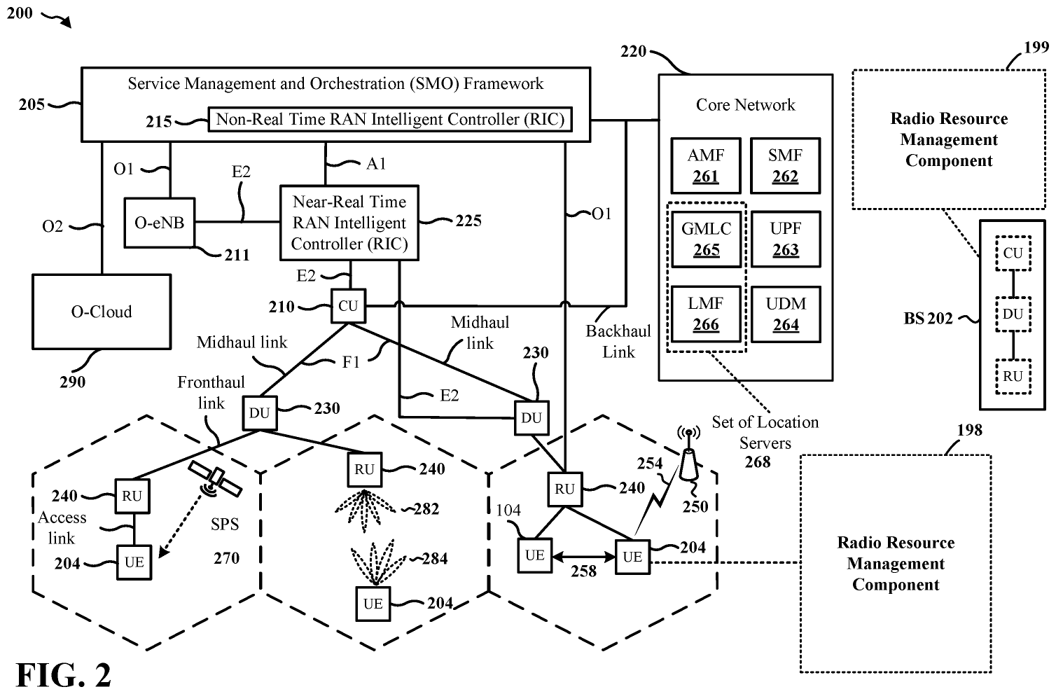

As an example, FIG. 2 shows a diagram illustrating architecture of an example of a disaggregated base station 200. The architecture of the disaggregated base station 200 may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC (e.g., a Non-RT RIC 215) associated with a Service Management and Orchestration (SMO) Framework (e.g., an SMO Framework 205), or both). A CU 210 may communicate with one or more DUs (e.g., a DU 230) via respective midhaul links, such as an F1 interface. The DU 230 may communicate with one or more RUs (e.g., an RU 240) via respective fronthaul links. The RU 240 may communicate with respective UE (e.g., the UE 204) via one or more radio frequency (RF) access links. In some implementations, the UE 204 may be simultaneously served by multiple RUS.

Each of the units, i.e., the CUS (e.g., a CU 210), the DUs (e.g., a DU 230), the RUs (e.g., an RU 240), as well as the Near-RT RICs (e.g., the Near-RT RIC 225), the Non-RT RICs (e.g., the Non-RT RIC 215), and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU 240 can be implemented to handle over the air (OTA) communication with one or more UE (e.g., the UE 204). In some implementations, real-time and non-real-time aspects of control and user plane communication with the RU 240 can be controlled by a corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs, DUs, RUS and Near-RT RICs. In some implementations, the SMO Framework 205 can communicate with a hardware aspect of a 4G RAN, such as an open eNB (O-cNB) 211, via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

At least one of the CU 210, the DU 230, and the RU 240 may be referred to as a base station 202. Accordingly, a base station 202 may include one or more of the CU 210, the DU 230, and the RU 240 (each component indicated with dotted lines to signify that each component may or may not be included in the base station 202). The base station 202 provides an access point to the core network 220 for the UE 204. The communication links between the RUs (e.g., the RU 240) and the UE (e.g., the UE 204) may include uplink (UL) (also referred to as reverse link) transmissions from the UE 204 to an RU 240 and/or downlink (DL) (also referred to as forward link) transmissions from an RU 240 to the UE 204.

Certain UE may communicate with each other using D2D communication (e.g., a D2D communication link 258). The D2D communication link 258 may use the DL/UL WWAN spectrum. The D2D communication link 258 may use one or more sidelink channels. D2D communication may be through a variety of wireless D2D communications systems, such as for example, Bluetooth, Wi-Fi based on the IEEE 802.11 standard, LTE, or NR.

The wireless communications system may further include a Wi-Fi AP 250 in communication with the UE 204 (also referred to as Wi-Fi STAs) via communication link 254, e.g., in a 5 GHz unlicensed frequency spectrum or the like. When communicating in an unlicensed frequency spectrum, the UE 204/Wi-Fi AP 250 may perform a CCA prior to communicating in order to determine whether the channel is available.

The base station 202 and the UE 204 may each include a plurality of antennas, such as antenna elements, antenna panels, and/or antenna arrays to facilitate beamforming. The base station 202 may transmit a beamformed signal 282 to the UE 204 in one or more transmit directions. The UE 204 may receive the beamformed signal from the base station 202 in one or more receive directions. The UE 204 may also transmit a beamformed signal 284 to the base station 202 in one or more transmit directions. The base station 202 may receive the beamformed signal from the UE 204 in one or more receive directions. The base station 202/UE 204 may perform beam training to determine the best receive and transmit directions for each of the base station 202/UE 204. The transmit and receive directions for the base station 202 may or may not be the same. The transmit and receive directions for the UE 204 may or may not be the same.

The core network 220 may include an Access and Mobility Management Function (AMF) (e.g., an AMF 261), a Session Management Function (SMF) (e.g., an SMF 262), a User Plane Function (UPF) (e.g., a UPF 263), a Unified Data Management (UDM) (e.g., a UDM 264), one or more location servers 268, and other functional entities. The AMF 261 is the control node that processes the signaling between the UE and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) (e.g., a GMLC 265) and a Location Management Function (LMF) (e.g., an LMF 266). However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 204 via the AMF 261 to compute the position of the UE 204. The NG-RAN may utilize one or more positioning methods in order to determine the position of the UE 204. Positioning the UE 204 may involve signal measurements, a position estimate, and an optional velocity computation based on the measurements. The signal measurements may be made by the UE 204 and/or the base station 202 serving the UE 204. The signals measured may be based on one or more of a satellite positioning system (SPS) 270 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Referring again to FIG. 2, in certain aspects, the UE 204 may include a radio resource management component 198. The radio resource management component 198 may be configured to receive, from a network entity, a DL WB RS based on an FMCW signal; and report, based on the DL WB RS, an RRM measurement that covers one or more sub-bands within one or more widebands of the FMCW signal. In certain aspects, the base station 202 may include a radio resource management component 199. The radio resource management component 199 may be configured to provide a DL WB RS based on an FMCW signal; and obtain, based on the DL WB RS, an RRM measurement of a UE, where the RRM measurement covers one or more sub-bands within a wideband of the FMCW signal. Although the following description may be focused on 5G NR, the concepts described herein may be applicable to other similar areas, such as LTE, LTE-A, CDMA, GSM, and other wireless technologies.

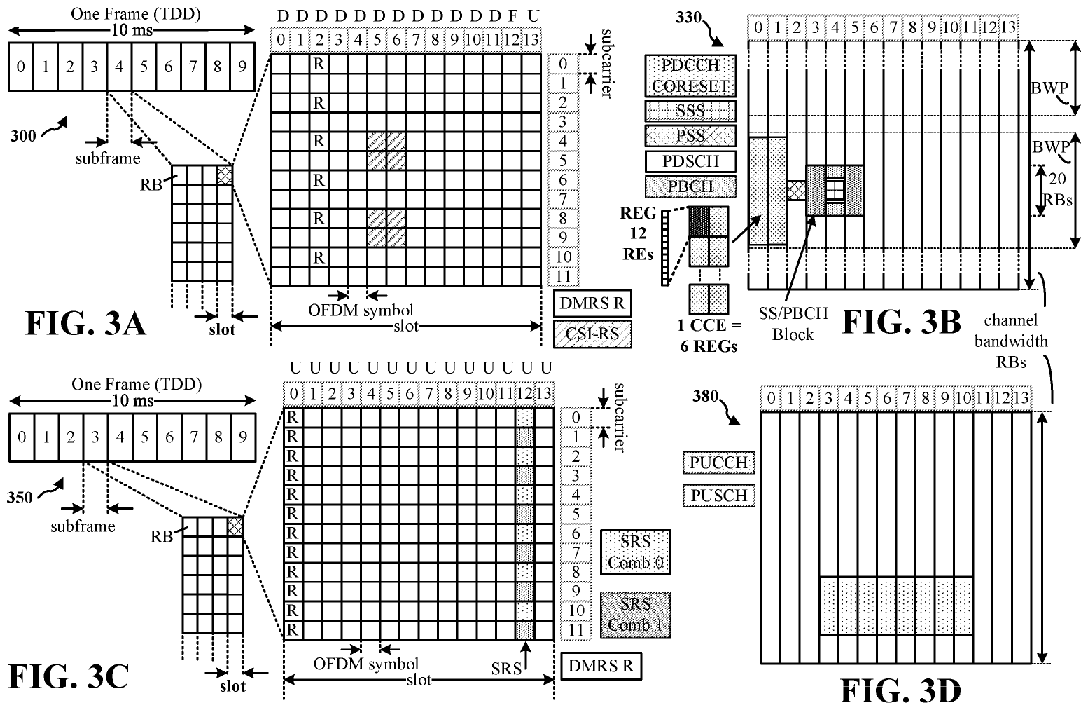

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UE are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. As shown in Table 1, the subcarrier spacing may be equal to 2ª *15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE, such as one of the UE 104 of FIG. 1 and/or the UE 204 of FIG. 2, to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

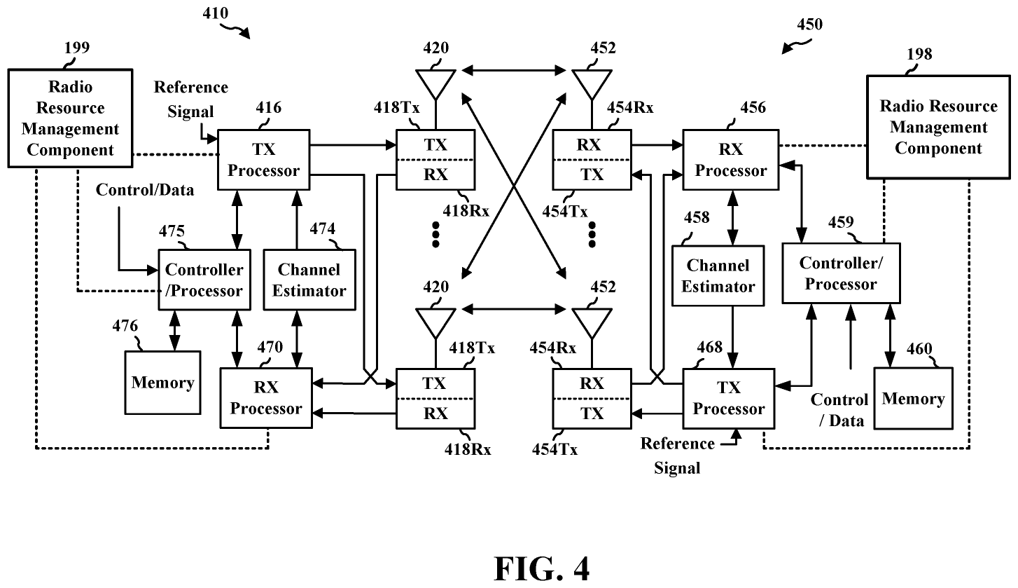

FIG. 4 is a block diagram that illustrates an example of a first wireless device that is configured to exchange wireless communication with a second wireless device. In the illustrated example of FIG. 4, the first wireless device may include a base station 410, the second wireless device may include the UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and at least one memory 476 (e.g., one or more memories). The example UE 450 includes antennas 452, a transmitter 454Tx, a receiver 454Rx, an RX processor 456, a channel estimator 458, a controller/processor 459, at least one memory 460 (e.g., one or more memories), and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the at least one memory 460 that stores program codes and data. The at least one memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the at least one memory 476 that stores program codes and data. The at least one memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the radio resource management component 198 of FIG. 1 and FIG. 2.

At least one of the TX processor 416, the RX processor 470, and the controller/processor 475 may be configured to perform aspects in connection with the radio resource management component 199 of FIG. 1 and FIG. 2.

Example aspects presented herein provide RRM enhancements based on using a wideband FMCW waveform including desired properties of the new waveform in RRM applications. The FMCW-based reference signal measurements help a network having a wider system bandwidth to accommodate UE that support a narrower bandwidth than the system bandwidth. The FMCW reference signal enables such UE to perform RRM measurements in a more efficient manner saving power at the UE and system overhead, e.g., by enabling fewer reference signal transmission and/or fewer reports from the UE to the network.

An FMCW signal (or an FMCW transmission) may include a continuous wave with a changing frequency. The frequency of the FMCW signal may be modulated or swept within a specific frequency range (e.g., ranging from a lower frequency to a higher frequency) in a continuous manner. A network may transmit an FMCW signal as a DL wideband (WB) channel sounding reference signal, which can be used for various applications including a wideband channel estimation. For example, an FMCW-based DL WB channel sounding reference signal may be used for channel estimation for system bandwidths larger than a bandwidth supported by a UE. For example, a UE may not support communications over wider system bandwidths, such as frequency bandwidths ranging from 400 MHz up to 8 GHZ for FR3, 6 GHZ, and sub-terahertz frequencies (frequencies below 300 GHZ), among other examples. Some UEs (e.g., mid-tier UE and Internet of Things (IoT) devices, among other examples) may not fully support a full bandwidth spectrum of a wireless communication system, and may support bandwidths of 20 MHz, 100 MHz, 400 MHZ, or 1 GHZ, among other examples.

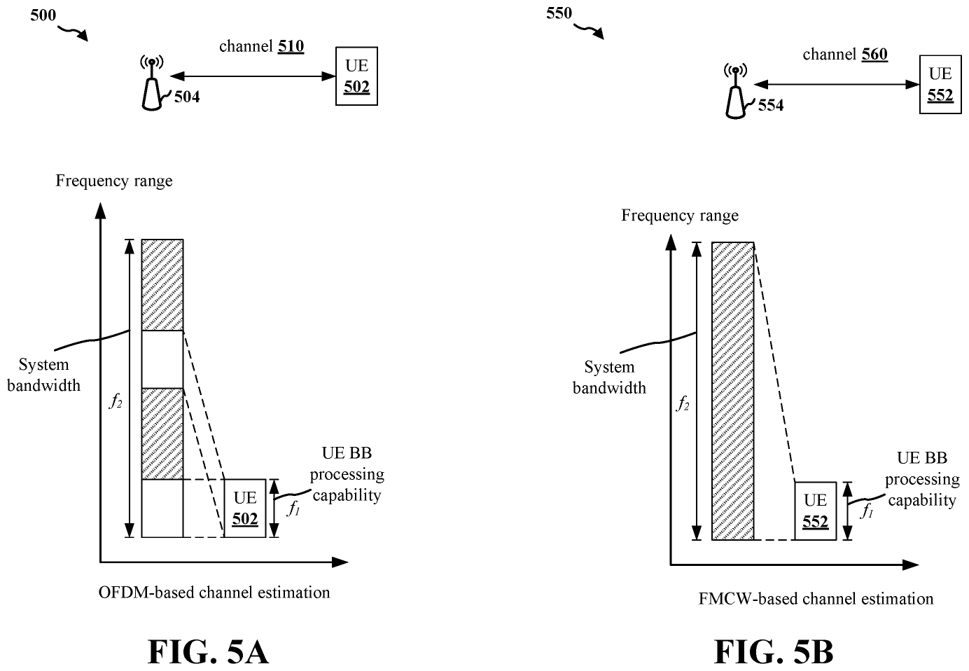

In some aspects, a UE supporting a bandwidth narrower than a system bandwidth may perform orthogonal frequency division multiplexing (OFDM)-based channel estimation. FIG. 5A is a diagram 500 illustrating an example of OFDM-based channel estimation. In FIG. 5A, due to the narrower baseband (BB) processing capability of the UE 502 (e.g., the processing capability of the UE 502 within the supported frequency band f₁), the UE 502 may not directly estimate the channel 510 between the based station 504 and the UE 502 over the entire bandwidth f₂. The UE 502 may use, for example, a frequency hopping technique, which involves transmitting multiple signals by changing, or hopping, among multiple frequency channels in a predefined sequence, to measure multiple narrowband signals at different frequencies in order to estimate the channel 510 between the base station 504 and the UE 502 over the entire bandwidth f₂.

FIG. 5B is a diagram 550 illustrating an example of FMCW-based channel estimation. In FIG. 5B, the UE 552, with a narrow band (e.g., f₁) BB processing capability, may estimate a wideband channel over the entire bandwidth (e.g., f₂) using the narrow band (e.g., f₁) in one measurement, and the UE may extract the channel 560 between the base station 554 and the UE 552 for the system bandwidth (e.g., f₂) from the narrow band baseband information (e.g., using the BB processing for f₁).

Wideband channel estimation enables the UE to scan a large bandwidth and identify one or more sub-bands for wireless communication. This scanning, which may be referred to as “large-scale” scanning as the UE is estimating channel information for a wideband using the narrow band processing capability, provides a comprehensive view of the available spectrum (e.g., system bandwidth), allowing the UE to select the suitable sub-bands for its specific use case and performance. In addition, from the network perspective, the configuration of resource efficiency may be similar to resources for UE-specific narrowband bandwidth part (NB BWP) allocations.

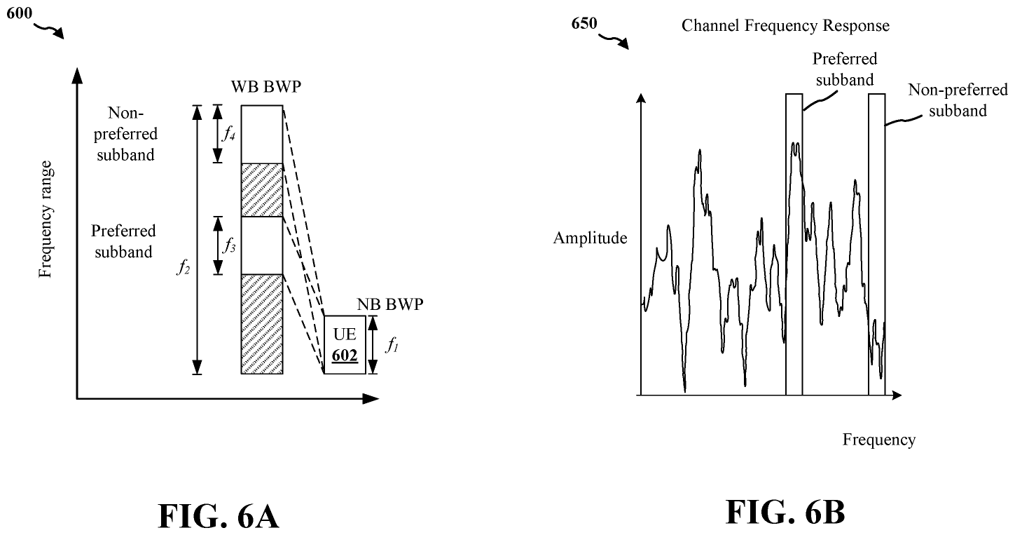

Within the system bandwidth, there may be preferred sub-bands for communication with the UE and non-preferred sub-bands for communication with the UE, e.g., based on a channel quality experienced for the UE on the respective sub-bands. As presented herein, a UE may measure the FMCW-based reference signal to identify one or more sub-bands as being preferred and/or one or more sub-bands as being non-preferred for communication with the UE. FIG. 6A is a diagram 600 that illustrates an example of preferred sub-bands based on an FMCW-based channel estimation. In FIG. 6A, the UE 602 has a narrow band (e.g., f₁) BB processing capability and may estimate a wideband channel over the system bandwidth (e.g., f₂ that may be referred to as an entire system bandwidth, full system bandwidth or complete system bandwidth). The UE may measure the FMCW-based reference signal (e.g., receiving the signal in a narrow band) and perform an estimation over the bandwidth (e.g., f₂), the UE may identify one or more preferred sub-bands (e.g., f₃) and/or one or more non-preferred sub-bands (e.g., f₄). The UE may identify the preferred and/or non-preferred sub-bands based on the characteristics of the sub-bands (e.g., the channel gain over the sub-bands) and the measurement of the FMCW reference signal. FIG. 6B illustrates an example graph 650 showing an example channel frequency response for a preferred sub-band and a non-preferred sub-band.

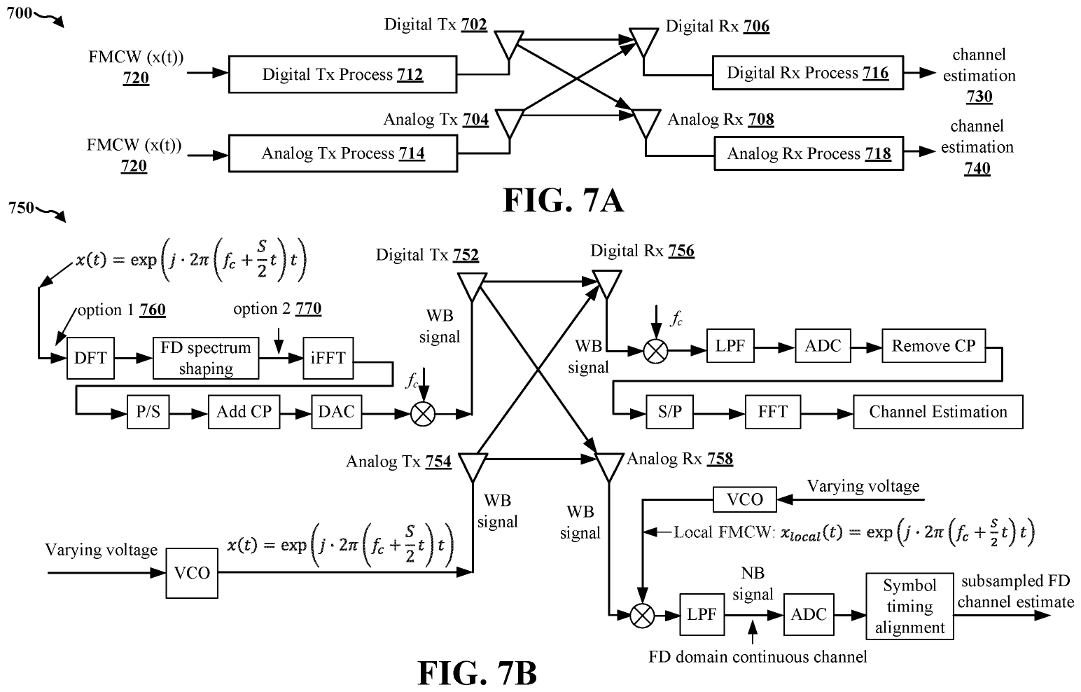

FIG. 7A is a diagram 700 illustrating examples of wideband channel estimation. In FIG. 7A, on the transmitter side, the FMCW signal (e.g., x(t)) 720 may be transmitted by either a digital transmitter 702 (through the digital Tx process 712) or an analog transmitter 704 (through the analog Tx process 714). On the receiver side, the FMCW signal may be received by a digital receiver 706 or an analog receiver 708. The signals received by the digital receiver 706 undergo the digital Rx process 716 to obtain the channel estimation 730. Similarly, the signals received by the analog receiver 708 undergo the analog Rx process 718 to obtain the channel estimation 740.

FIG. 7B is a diagram 750 illustrating examples of wideband channel estimation. In FIG. 7B, on the transmitter side, the FMCW signal (e.g., x(t)) may be transmitted by either a digital transmitter 752 or an analog transmitter 754. When the FMCW signal is transmitted using the digital transmitter 752, in some examples, the FMCW signal may be regarded as a time domain sequence (e.g., at option 1 760). In some examples, the FMCW signal may be regarded as a frequency domain sequence (e.g., at option 2 770). On the receiver side, the FMCW signal may be received by a digital receiver 756 or an analog receiver 758.

In comparison to digital Rx processing, the analog FMCW Rx processing has a lower Analog-to-Digital Converter (ADC) rate, resulting in significant cost saving and improved power efficiency. As an example, as the frequency domain (FD) channel estimate resolution decreases, the ADC similarly reduces, leading to substantial cost savings. Measuring the wideband channel using a narrowband baseband (NB BB) chain may further improve the power consumption. Table 2 shows a comparison of sampling rate/ADC under different exemplary BWs and SCSs. As shown in Table 2, using an analog receiver may reduce the required sampling rate. For example, the sampling rate using an exemplary analog receiver is 6.67% of that using an exemplary digital receiver).

TABLE 2
Comparison of sampling rate/ADC under
different exemplary BWs and SCSs

| | | | | Sampling rate/ADC | |
|---|---|---|---|---|---|
| | Samples | | | with analog Rx (per- | |
| | per sym- | Sampling rate/ | | RB channel | |
| | bols with | ADC with | | estimation | |
| BW/SCS | digital Rx | digital Rx | | granularity) | |
| 100 MHz, 30 KHz | 4096 | 122.88 | MHz | 8.19 | MHz |
| 400 MHz, 30 KHz | 16384 | 491.52 | MHz | 32.76 | MHz |
| 400 MHz, 120 KHz | 4096 | 491.52 | MHz | 32.76 | MHz |
| 1600 MHz, 120 KHz | 16384 | 1966.08 | MHz | 131.04 | MHz |

| | |
|---|---|
| ADC comparison | 6.67% of digital Rx |

In wireless communication, the RRM may be based on SSB measurements or CSI-RS measurements. FIG. 3B illustrates example aspects of an SSB. The RRM measurements may include any of various types of measurements. As an example, SSB based measurements may include various quantities, such as reference signal received power (RSRP), reference signal received quality (RSRQ), and signal-to-interference-plus-noise ratio (SINR), may be narrowband measurements that include long term averages to mitigate the channel fading effects, e.g., the variation in channel characteristics or channel quality at different frequencies. For example, the radio signal quality may vary due to any combination of external factors (e.g., pathloss, multipath, among other examples) as the signal travels from the transmitter to the receiver. Hence, isolated SSB measurements, e.g., a single narrowband SSB measurement or a few narrowband SSB measurements, may not reflect the channels accurately, and may not account for the channel fading effects.

Additionally, the long term averaging on the measurements may help to mitigate a ping-pong effect (e.g., an unnecessarily frequent handover of cells due to the irregularity that is associated with the short-term measurement). For example, if the cell measurements for two cells are similar, the UE may select a first cell, then move to the second cell, then move back to the first cell, and so forth. The long-term average (e.g., layer 3 (L3) average) may result in the UE having to awaken more frequently to report its RRM measurements, leading to added power consumption at the UE.

For some wireless applications (as one non-limiting example, for 6G wireless communication), the narrowband UE may be configured to measure multiple carriers spanning a broad wideband. However, multiple SSB based RRM measurements for such a wideband carrier may not be fully supported for some UEs.

A network may send a configuration to a UE to perform inter-frequency measurements. The configuration may configure the UE to perform measurements based on an SSB measurement timing configuration (SMTC). The network may provide an SMTC configuration to the UE for each frequency of multiple frequencies within the system bandwidth.

On the other hand, if the UE supports measuring the wideband channel in one measurement, the single measurement could decrease the number of measurement gaps needed for RRM. In addition to conserving power at the UE, this would release a considerable amount of time and frequency resources for other data or control traffic, thus reducing the latency of the system.

Based on the considerations and observations described above, example aspects presented herein provide methods and apparatus for RRM based on the WB FMCW measurements.

In some aspects, the FMCW-based measurement quantities for RRM may be defined. These quantities may include, for example, RSRP, RSRQ, and SINR for FMCW-based measurements. The FMCW transmission may be within the SMTC, as the mechanisms associated with SSB/CSI-RS based RRM.

In some examples, the FMCW-based RRM measurement may support one-shot wideband carrier RRM measurements. For example, a UE may leverage the frequency diversity in the WB measurement to average (e.g., mitigate) the channel fading effect. As a result, the network might be able to configure RRM measurements with a reduced frequency or larger periodicity through SMTC configurations. Additionally, the UE may have the flexibility to report RRM measurements based on either a single or multiple sub-band, and the UE may report of the RSRP measurement based on one or several sub-bands. To mitigate the ping-pong effect on mobility, multiple FMCWs may be configured within an SMTC.

In some aspects, the FMCW may be compatible with UE's voltage-controlled oscillator (VCO)-based measurements with a narrowband baseband. There may not be a frequency jump during the FMCW frequency sweep. For example, the FMCW-based signal may continuously cover the frequency domain within the frequency range of the FMCW signal (e.g., continuously cover the frequency domain from the lower limit to the upper limit of the frequency range).

In some examples, the FMCW may be scrambled using another sequence, like the Gold sequence (a sequence with good cross-correlation and autocorrelation properties, which may be used to distinctly identify different users' signal), with at least one of the cell identification (ID) or beam ID as the scrambling seed. To reduce the complexity, the scramble sequence may have a short length (e.g., the length of 64 or 256). In some examples, the scrambling process may be performed in the time domain or the frequency domain. For example, in the scrambling process, certain mathematical transformations (based on the scramble sequence) may be applied to the FMCW in the time domain or frequency domain to produce a scrambled signal.

In some aspects, the FMCW mechanism for RRM measurements may be on-demand (e.g., with FMCW RS transmission in response to a UE request). Due to the WB resource allocation for FMCW, it may not be transmitted frequently in the network. Therefore, it may be jointly configured with other RRM RS, such as SSB. In this context, the default RS for RRM may be SSB for narrowband measurements.

The on-demand FMCW for RRM measurements may be implemented in various ways. In one configuration, the UE may transmit a request for WB FMCW measurements to the network, either for additional measurements or to achieve low latency and power savings through one-shot measurements. In some examples, the UE may transmit a request for a WB FMCW RS from a specific cell or beam. In some examples, the UE may request or otherwise indicate the periodicity of the WB FMCW.

In one configuration, the network (e.g., the base station) may configure the WB FMCW-based RRM measurements through event-based RRM measurement reports. The measurement report types or events may be defined in a wireless communication specification or standards with additional WB FMCW measurements. In some examples, the events may be correlated with sudden changes of the UE mobility, and a low latency measurement (e.g., measurements without going through L3 average) may enhance the overall system efficiency. For example, considering a scenario where the UE moves from the cell center to the cell edge but suddenly returns to the cell center. In such a situation, they network may want to quickly confirm the UE's mobility through some quick one-shot measurements to potentially cancel some planned handovers.

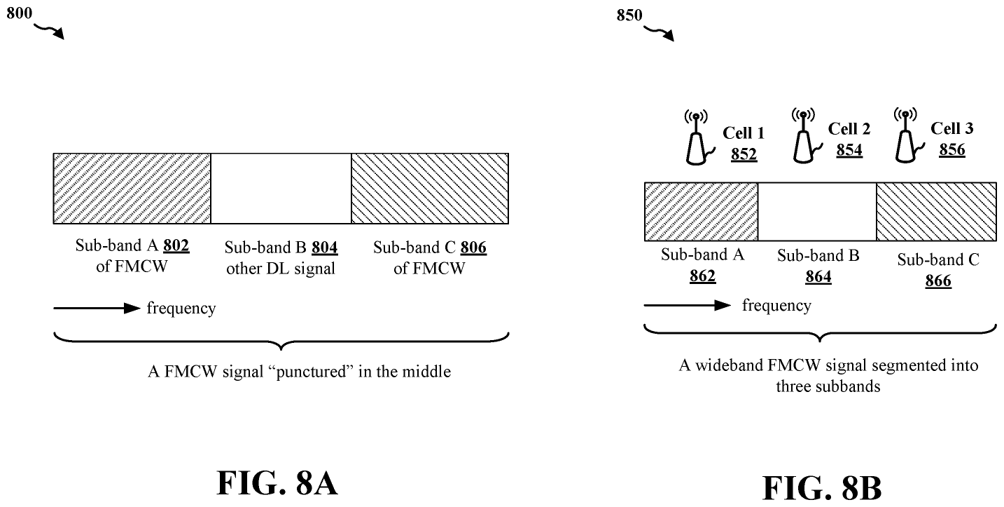

In some aspects, the FMCW RRM configuration may be integrated with sub-band configurations. In some examples, the WB FMCW signal may be punctured in frequency or frequency division multiplexed (FDM'ed) with other DL signals. For example, the FMCW signal may be punctured with a second DL signal in the frequency domain or a gap in the frequency domain. FIG. 8A is a diagram 800 illustrating an example of an FMCW signal punctured in the frequency domain in accordance with various aspects of the present disclosure. FIG. 8A shows that the FMCW signal is non-contiguous in the frequency domain and has the other DL signal (e.g., the second DL signal occupying sub-band B 804) between portions of the FMCW signal on different sub-bands, such as sub-band A 802 and sub-band C 806. In FIG. 8A, the FMCW signal may be punctured with another DL signal (the second DL signal) in the frequency domain. The FMCW signal may occupy sub-band A 802 and sub-band C 806 in the frequency domain, and the second DL signal may occupy sub-band B 804 in the frequency domain. Sub-band B 804 may be located in between sub-band A 802 and sub-band C 806. In some examples, each of the sub-bands may also be wideband.

In some examples, if a wideband carrier is segmented into multiple sub-bands, and each sub-band is used by a distinct cell, these cells may coordinate to transmit a wideband FMCW signal. For example, a UE may receive the DL WB RS from multiple cells (or network entities), and one sub-band of the one or more sub-bands associated with the FMCW signal may be from each cell (or network entity) of the multiple cells (or network entities). FIG. 8B is a diagram 850 illustrating an example of the coordinated transmission of a wideband FMCW signal by multiple cells in accordance with various aspects of the present disclosure. In FIG. 8B, a wideband FMCW signal may be segmented into multiple sub-bands, such as sub-band A 862, sub-band B 864, and sub-band C 866. Each of these sub-bands may be used by a different cell. For example, sub-band A 862 may be used by cell 1 852, sub-band B 864 may be used by cell 2 854, and sub-band C 866 may be used by cell 3 856. These cells (e.g., cell 1 862, cell 2 864, and cell 3 866) may be coordinated to transmit the wideband FMCW signal.

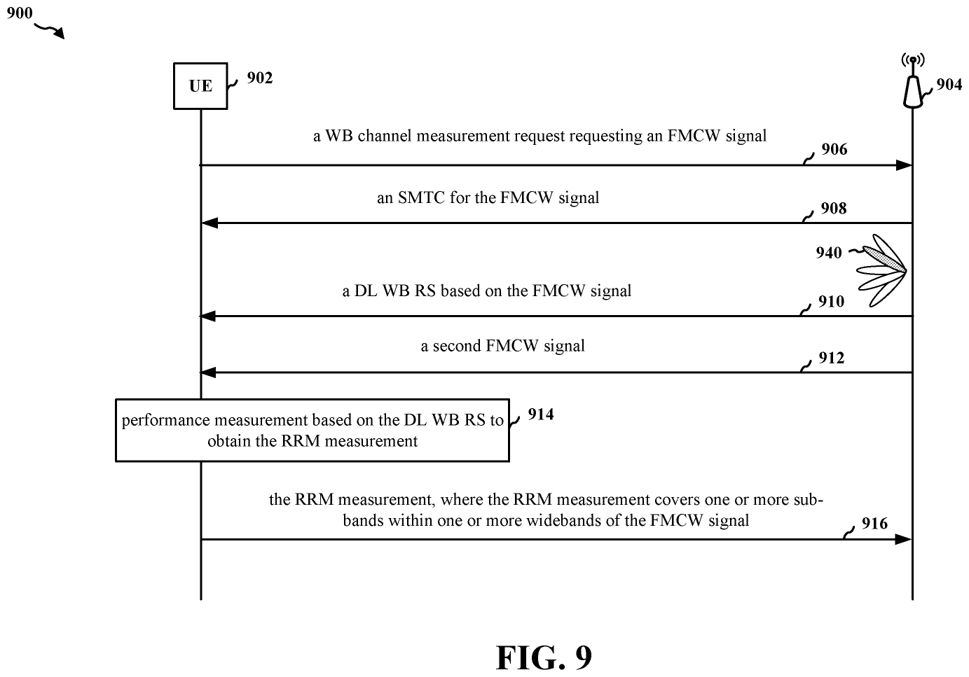

FIG. 9 is a call flow diagram 900 illustrating a method of wireless communication in accordance with various aspects of this present disclosure. Various aspects are described in connection with the UE 902 and a base station 904. The aspects may be performed by the UE 902 or the base station 904 in aggregation and/or by one or more components of a base station 904 (e.g., such as a CU 210, a DU 230, and/or an RU 240).

As shown in FIG. 9, at 906, the UE 902 may transmit a WB channel measurement request to the base station 904. The WB channel measurement request may request an FMCW signal.

At 908, the UE 902 may receive an SMTC for the FMCW signal from the base station 904. The FMCW may define a time window for the FMCW signal.

At 910, the UE 902 may receive a DL WB RS based on the FMCW signal from the base station 904. In some examples, the UE 902 may receive the DL WB RS via a transmitting beam 940. The transmitting beam 940 may be indicated by the WB channel measurement request (at 906) that requests the FMCW signal. For example, the WB channel measurement request (at 906) may indicate the transmitting beam 940 via a beam ID. In some examples, multiple network entities (or base stations) may coordinate to transmit the FMCW signal, and each network entity (or base station) may use one sub-band of the multiple sub-bands associated with the FMCW signal. For example, referring to FIG. 8B, a FMCW signal may be segmented into three sub-bands (e.g., sub-band A 862, sub-band B 864, and sub-band C 866) in the frequency domain, the sub-bands may be used by different network entities (e.g., sub-band A 862 is used by cell 1 852, sub-band B 864 is used by cell 2 854, and sub-band C 866 is used by cell 3 856).

In some aspects, at 912, the UE 902 may receive a second DL WB RS signal from the base station 904. The second FMCW signal may be configured within the time window defined by the SMTC.

At 914, the UE 902 may perform measurements based on the DL WB RS to obtain the RRM measurement. For example, the RRM measurement may measure the RSRP based on the FMCW signal, the RSRQ based on the FMCW signal, or the SINR based on the FMCW signal.

At 916, the base station 904 may report the RRM measurement to the base station 904. The RRM measurement may cover one or more sub-bands within one or more widebands of the FMCW signal.

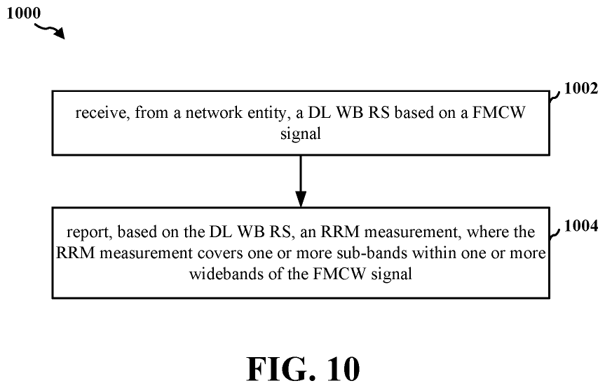

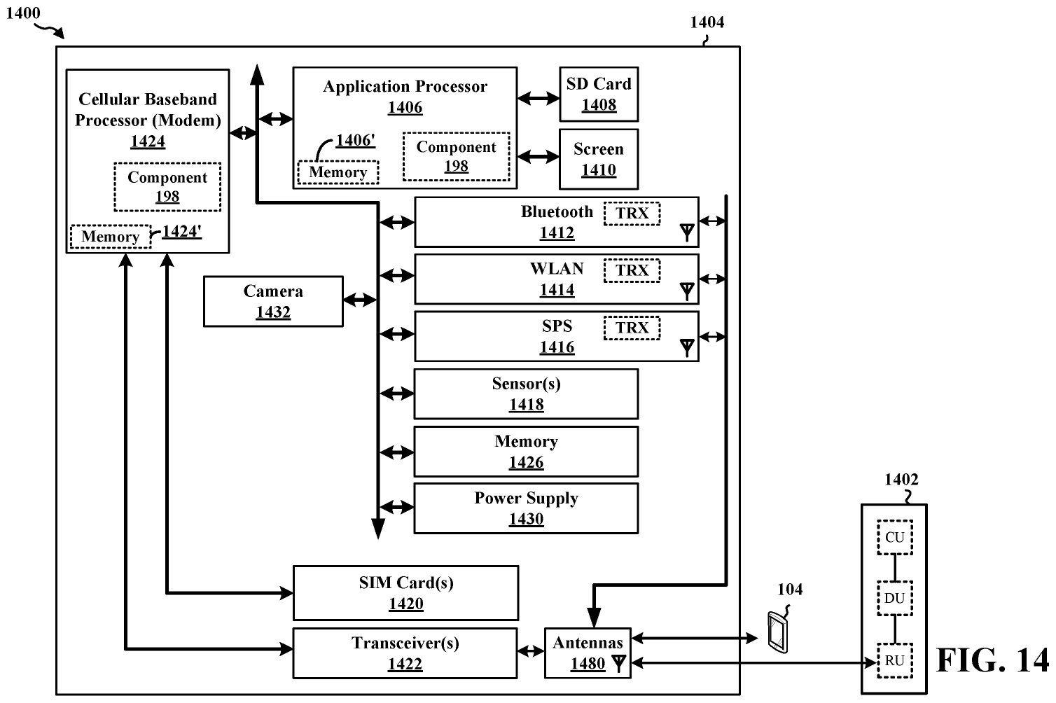

FIG. 10 is a flowchart 1000 illustrating methods of wireless communication at a UE in accordance with various aspects of the present disclosure. The method may be performed by a UE. The UE may be the UE 104, 450, 902, or the apparatus 1404 in the hardware implementation of FIG. 14. By utilizing an FMCW-based DL WB RS, the methods enable the UE to scan and identify preferred sub-bands across a wideband, accommodating the UE that may not fully support the entire wideband. The methods further support an on-demand FMCW for additional measurements to reduce signaling overhead and power consumption. Hence, the methods optimize the usage of available bandwidth and improve the overall efficiency of wireless communication.

As shown in FIG. 10, at 1002, the UE may receive, from a network entity, a DL WB RS based on an FMCW signal. The network entity may be a base station, or a component of a base station, in the access network of FIG. 1 or a core network component (e.g., base station 102, 410, 904; or the network entity 1402 in the hardware implementation of FIG. 14). FIG. 9 illustrates various aspects in connection with flowchart 1000. For example, referring to FIG. 9, the UE 902 may receive, at 910, from a network entity (base station 904), a DL WB RS based on an FMCW signal. In some aspects, 1002 may be performed by the radio resource management component 198.

At 1004, the UE may report, based on the DL WB RS, an RRM measurement that covers one or more sub-bands within one or more widebands of the FMCW signal. For example, referring to FIG. 9, the UE 902 may report, at 916, an RRM measurement to the base station 904. The RRM measurement may be based on the DL WB RS (received at 910) and may cover one or more sub-bands within one or more widebands of the FMCW signal. In some aspects, 1004 may be performed by the radio resource management component 198.

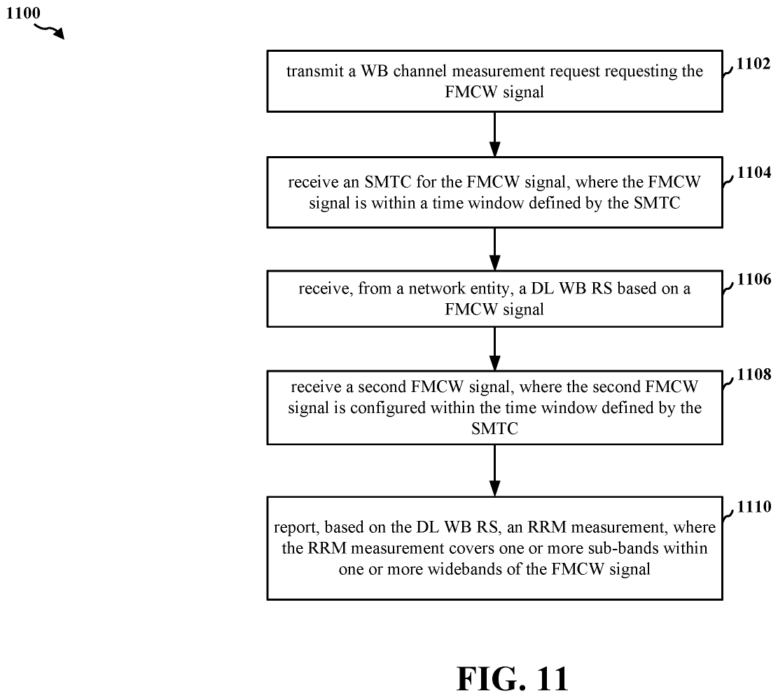

FIG. 11 is a flowchart 1100 illustrating methods of wireless communication at a UE in accordance with various aspects of the present disclosure. The method may be performed by a UE. The UE may be the UE 104, 450, 902, or the apparatus 1404 in the hardware implementation of FIG. 14. By utilizing an FMCW-based DL WB RS, the methods enable the UE to scan and identify preferred sub-bands across a wideband, accommodating the UE that may not fully support the entire wideband. The methods further support an on-demand FMCW for additional measurements to reduce signaling overhead and power consumption at the UE. Hence, the methods optimize the usage of available bandwidth and improve the overall efficiency of wireless communication.

As shown in FIG. 11, at 1106, the UE may receive, from a network entity, a DL WB RS based on an FMCW signal. The network entity may be a base station, or a component of a base station, in the access network of FIG. 1 or FIG. 2 or a core network component (e.g., base station 102, 410, 904; or the network entity 1402 in the hardware implementation of FIG. 14). FIGS. 8A, 8B, and 9 illustrate various aspects in connection with flowchart 1100. For example, referring to FIG. 9, the UE 902 may receive, at 910, from a network entity (base station 904), a DL WB RS based on an FMCW signal. In some aspects, 1106 may be performed by the radio resource management component 198.

At 1110, the UE may report, based on the DL WB RS, an RRM measurement that covers one or more sub-bands within one or more widebands of the FMCW signal. For example, referring to FIG. 9, the UE 902 may report, at 916, an RRM measurement to the base station 904. The RRM measurement may be based on the DL WB RS (received at 910) and may cover one or more sub-bands within one or more widebands of the FMCW signal. In some aspects, 1110 may be performed by the radio resource management component 198.

In some aspects, the RRM measurement may measure one or more of: the RSRP based on the FMCW signal, the RSRQ based on the FMCW signal, or the SINR based on the FMCW signal. For example, referring to FIG. 9, the RRM measurement (at 916) may measure one or more of: the RSRP based on the FMCW signal (at 910), the RSRQ based on the FMCW signal (at 910), or the SINR based on the FMCW signal (at 910).

In some aspects, at 1104, the UE may receive an SMTC for the FMCW signal, and the FMCW signal may be within a time window defined by the SMTC. For example, referring to FIG. 9, the UE 902 may receive, at 908, an SMTC for the FMCW signal, and the FMCW signal (at 910) may be within a time window defined by the SMTC. In some aspects, 1104 may be performed by the radio resource management component 198.

In some aspects, the FMCW signal may be a first FMCW signal, and the UE may, at 1108, receive a second FMCW signal. The second FMCW signal may be configured within the time window defined by the SMTC (received at 1104). For example, referring to FIG. 9, the UE 902 may receive, at 912, a second FMCW signal. The second FMCW signal may be configured within the time window defined by the SMTC (at 908). In some aspects, 1108 may be performed by the radio resource management component 198.

In some aspects, the RRM measurement may include one or more sub-band measurements respectively corresponding to the one or more sub-bands, and to report the RRM measurement (at 1110), the UE may report the RRM measurement based on the one or more sub-band measurements. For example, referring to FIG. 9, the RRM measurement (at 916) may include one or more sub-band measurements respectively corresponding to the one or more sub-bands. Referring to FIG. 8A, the RRM measurement may include one or more sub-band measurements respectively corresponding to the one or more sub-bands (e.g., sub-band A 802 and sub-band C 806).

In some aspects, the FMCW signal may include component signals continuously changing within a frequency range from a first frequency to a second frequency, and the component signals may continuously cover the frequency domain from the first frequency to the second frequency (i.e., there is no frequency gap in the component signals in the frequency range from the first frequency to the second frequency). For example, referring to FIG. 9, the FMCW signal (at 910) may include component signals continuously changing within a frequency range from a first frequency to a second frequency, and there may be no frequency gap in the component signals in the frequency range from the first frequency to the second frequency.

In some aspects, the FMCW signal may be scrambled with a scrambling sequence with at least one of a cell ID or a beam ID. For example, referring to FIG. 9, the FMCW signal (at 910) may be scrambled with a scrambling sequence with at least one of a cell ID or a beam ID.

In some aspects, the FMCW signal may be scrambled with the scrambling sequence at the time domain or the frequency domain. For example, referring to FIG. 9, the FMCW signal (at 910) may be scrambled with the scrambling sequence at the time domain or the frequency domain.

In some aspects, at 1102, the UE may transmit a WB channel measurement request requesting the FMCW signal, and to receiving the DL WB RS (at 1106), the UE may receive the DL WB RS in response to the WB channel measurement request. For example, referring to FIG. 9, the UE 902 may transmit, at 906, a WB channel measurement request requesting the FMCW signal, and the UE 902 may receive the DL WB RS (at 910) in response to the WB channel measurement request. In some aspects. 1102 may be performed by the radio resource management component 198.

In some aspects, the WB channel measurement request may further include a cell ID identifying a source network entity or a beam ID identifying a transmitting beam, and to receive the DL WB RS (at 1106), the UE may receive the DL WB RS from the source network entity or via the transmitting beam. For example, referring to FIG. 9, the WB channel measurement request (at 906) may further include a cell ID identifying a source network entity or a beam ID identifying a transmitting beam 940, and the UE 902 may receive the DL WB RS from the source network entity or via the transmitting beam 940.

In some aspects, the WB channel measurement request may further include a periodicity, and to receive the DL WB RS (at 1106), the UE may receive the DL WB RS periodically based on the periodicity from the WB channel measurement request. For example, referring to FIG. 9, the WB channel measurement request (at 906) may further include a periodicity, and the UE 902 may receive the DL WB RS (at 910) periodically based on the periodicity from the WB channel measurement request.

In some aspects, to receive the DL WB RS (at 1106), the UE may receive the DL WB RS based on an RRM measurement report indicating an event associated with the UE. For example, referring to FIG. 9, the UE 902 may receive the DL WB RS (at 910) based on an RRM measurement report indicating an event associated with the UE 902.

In some aspects, the event associated with the UE may indicate a change of a UE mobility. For example, referring to FIG. 9, the event associated with the UE 902 may indicate a change of a UE mobility.

In some aspects, the FMCW signal may be punctured with a second DL signal in the frequency domain or a gap in the frequency domain. For example, referring to FIG. 9, the FMCW signal (at 910) may be punctured with a second DL signal in the frequency domain or a gap in the frequency domain. Referring to FIG. 8A, the FMCW signal may be punctured with a second DL signal (at Sub-band B 804) in the frequency domain. In some examples, the sub-band B 804 may be a gap in the frequency domain.

In some aspects, the network entity may be a first network entity, and to receive the DL WB RS (at 1106), the UE may receive the DL WB RS from multiple network entities including the first network entity, and one sub-band of the one or more sub-bands associated with the FMCW signal may be from each network entity of the multiple network entities. For example, referring to FIG. 8B, the UE may receive the DL WB RS from multiple network entities (e.g., cell 1 852, cell 2 854, and cell 3 856) and one sub-band of the one or more sub-bands associated with the FMCW signal may be from each network entity of the multiple network entities. For example, sub-band A 862 may be associated with cell 1 852, sub-band B 864 may be associated with cell 2 854, and sub-band C 866 may be associated with cell 3 856.

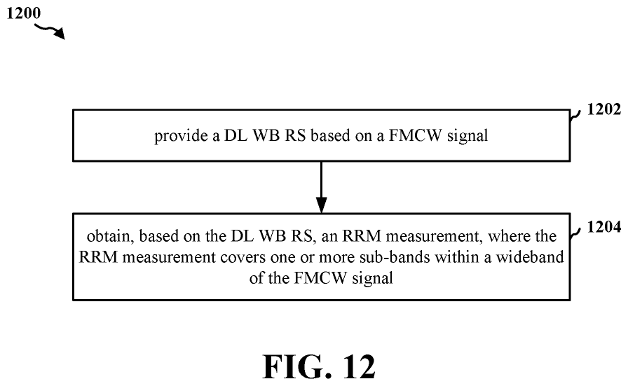

FIG. 12 is a flowchart 1200 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 410, 904; or the network entity 1402 in the hardware implementation of FIG. 14). By utilizing an FMCW-based DL WB RS, the methods enable the UE to scan and identify preferred sub-bands across a wideband, accommodating the UE that may not fully support the entire wideband. The methods further support an on-demand FMCW for additional measurements to reduce signaling overhead and power consumption. Hence, the methods optimize the usage of available bandwidth and improve the overall efficiency of wireless communication.

As shown in FIG. 12, at 1202, the network entity may provide a DL WB RS based on an FMCW signal. The UE may be the UE 104, 450, 902, or the apparatus 1404 in the hardware implementation of FIG. 14. FIG. 9 illustrates various aspects in connection with flowchart 1200. For example, referring to FIG. 9, the network entity (base station 904) may provide, at 910, a DL WB RS based on an FMCW signal. In some aspects, 1202 may be performed by the radio resource management component 199.

At 1204, the network entity may obtain, based on the DL WB RS, an RRM measurement of a UE. The RRM measurement may cover one or more sub-bands within a wideband of the FMCW signal. For example, referring to FIG. 9, the network entity (base station 904) may obtain, at 916, an RRM measurement of the UE 902. The RRM measurement may be based on the DL WB RS (at 910) and may cover one or more sub-bands within a wideband of the FMCW signal. In some aspects, 1204 may be performed by the radio resource management component 199.

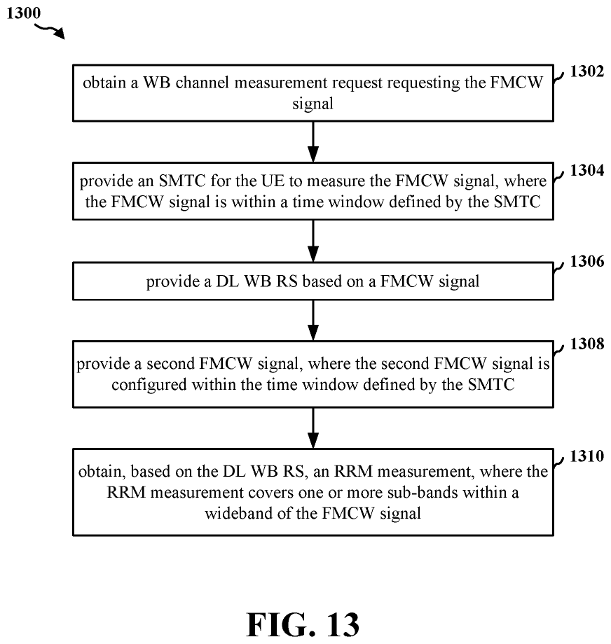

FIG. 13 is a flowchart 1300 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 410, 904; or the network entity 1402 in the hardware implementation of FIG. 14). By utilizing an FMCW-based DL WB RS, the methods enable the UE to scan and identify preferred sub-bands across a wideband, accommodating the UE that may not fully support the entire wideband. The methods further support an on-demand FMCW for additional measurements to reduce signaling overhead and power consumption. Hence, the methods optimize the usage of available bandwidth and improve the overall efficiency of wireless communication.

As shown in FIG. 13, at 1306, the network entity may provide a DL WB RS based on an FMCW signal. The UE may be the UE 104, 450, 902, or the apparatus 1404 in the hardware implementation of FIG. 14. FIGS. 8A, 8B, and 9 illustrate various aspects in connection with flowchart 1300. For example, referring to FIG. 9, the network entity (base station 904) may provide, at 910, a DL WB RS based on an FMCW signal. In some aspects, 1306 may be performed by the radio resource management component 199.

At 1310, the network entity may obtain, based on the DL WB RS, an RRM measurement of a UE. The RRM measurement may cover one or more sub-bands within a wideband of the FMCW signal. For example, referring to FIG. 9, the network entity (base station 904) may obtain, at 916, an RRM measurement of the UE 902. The RRM measurement may be based on the DL WB RS (at 910) and may cover one or more sub-bands within a wideband of the FMCW signal. In some aspects, 1310 may be performed by the radio resource management component 199.

In some aspects, the RRM measurement may measure one or more of the RSRP based on the FMCW signal, the RSRQ based on the FMCW signal, or the SINR based on the FMCW signal. For example, referring to FIG. 9, the RRM measurement (at 916) may measure one or more of: the RSRP based on the FMCW signal (at 910), the RSRQ based on the FMCW signal (at 910), or the SINR based on the FMCW signal (at 910).

In some aspects, at 1304, the network entity may provide an SMTC for the UE to measure the FMCW signal, and the FMCW signal may be within a time window defined by the SMTC. For example, referring to FIG. 9, the UE 902 may receive, at 908, an SMTC for the FMCW signal, and the FMCW signal (at 910) may be within a time window defined by the SMTC. In some aspects, 1304 may be performed by the radio resource management component 199.

In some aspects, the FMCW signal may be a first FMCW signal, and the network entity may, at 1308, provide a second FMCW signal. The second FMCW signal may be configured within the time window defined by the SMTC. For example, referring to FIG. 9, the UE 902 may receive, at 912, a second FMCW signal. The second FMCW signal may be configured within the time window defined by the SMTC (at 908). In some aspects, 1308 may be performed by the radio resource management component 199.

In some aspects, the RRM measurement may include one or more sub-band measurements respectively corresponding to the one or more sub-bands, and to obtain the RRM measurement (at 1310), the network entity may obtain the RRM measurement based on the one or more sub-band measurements. For example, referring to FIG. 9, the RRM measurement (at 916) may include one or more sub-band measurements respectively corresponding to the one or more sub-bands. Referring to FIG. 8A, the RRM measurement may include one or more sub-band measurements respectively corresponding to the one or more sub-bands (e.g., sub-band A 802 and sub-band C 806).

In some aspects, the FMCW signal may include component signals continuously changing within a frequency range from a first frequency to a second frequency, and the components signals may continuously cover the frequency domain from the first frequency to the second frequency (i.e., there is no frequency gap in the component signals within the frequency range from the first frequency to the second frequency). For example, referring to FIG. 9, the FMCW signal (at 910) may include component signals continuously changing within a frequency range from a first frequency to a second frequency, and there may be no frequency gap in the component signals in the frequency range from the first frequency to the second frequency.

In some aspects, the FMCW signal may be scrambled with a scrambling sequence with at least one of a cell ID or a beam ID. For example, referring to FIG. 9, the FMCW signal (at 910) may be scrambled with a scrambling sequence with at least one of a cell ID or a beam ID.

In some aspects, the FMCW signal may be scrambled with the scrambling sequence at the time domain or the frequency domain. For example, referring to FIG. 9, the FMCW signal (at 910) may be scrambled with the scrambling sequence at the time domain or the frequency domain.

In some aspects, at 1302, the network entity may obtain a WB channel measurement request requesting the FMCW signal, and to provide the DL WB RS (at 1306), the network entity may provide the DL WB RS in response to the WB channel measurement request. For example, referring to FIG. 9, the network entity (base station 904) may obtain, at 906, a WB channel measurement request requesting the FMCW signal, and the network entity (base station 904) may provide the DL WB RS (at 910) in response to the WB channel measurement request. In some aspects, 1302 may be performed by the radio resource management component 199.

In some aspects, the WB channel measurement request may further include a cell ID identifying a source network entity, and to provide the DL WB RS (at 1306), the network entity may provide the DL WB RS in response to the cell ID matching the cell ID of the network entity. For example, referring to FIG. 9, the WB channel measurement request (at 906) may further include a cell ID identifying a source network entity, and the network entity (base station 904) may provide the DL WB RS, at 910, in response to the cell ID matching the cell ID of the network entity (base station 904).

In some aspects, the WB channel measurement request may further include a periodicity or a beam ID identifying a transmitting beam, and to provide the DL WB RS (at 1306), the network entity may provide the DL WB RS periodically based on the periodicity or provide the DL WB RS using the transmitting beam. For example, referring to FIG. 9, the WB channel measurement request (at 906) may further include a periodicity or a beam ID identifying a transmitting beam (e.g., beam 940), and the network entity (base station 904) may provide the DL WB RS (at 910) periodically based on the periodicity or provide the DL WB RS using the transmitting beam (beam 940).

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor (or processing circuitry) 1424 (also referred to as a modem) coupled to one or more transceivers 1422 (e.g., cellular RF transceiver). The cellular baseband processor(s) (or processing circuitry) 1424 may include at least one on-chip memory (or memory circuitry) 1424′. In some aspects, the apparatus 1404 may further include one or more subscriber identity modules (SIM) cards 1420 and at least one application processor (or processing circuitry) 1406 coupled to a secure digital (SD) card 1408 and a screen 1410. The application processor(s) (or processing circuitry) 1406 may include on-chip memory (or memory circuitry) 1306′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) (or processing circuitry) 1424 communicates through the transceiver(s) 1422 via one or more antennas 1480 with the UE 104 and/or with an RU associated with a network entity 1402. The cellular baseband processor(s) (or processing circuitry) 1424 and the application processor(s) (or processing circuitry) 1406 may each include a computer-readable medium/memory (or memory circuitry) 1424′, 1406′, respectively. The additional memory modules 1426 may also be considered a computer-readable medium/memory (or memory circuitry). Each computer-readable medium/memory (or memory circuitry) 1424′, 1406′, 1426 may be non-transitory. The cellular baseband processor(s) (or processing circuitry) 1424 and the application processor(s) (or processing circuitry) 1406 are each responsible for general processing, including the execution of software stored on the computer-readable medium/memory (or memory circuitry). The software, when executed by the cellular baseband processor(s) (or processing circuitry) 1424/application processor(s) (or processing circuitry) 1406, causes the cellular baseband processor(s) (or processing circuitry) 1424/application processor(s) (or processing circuitry) 1406 to perform the various functions described supra. The cellular baseband processor(s) (or processing circuitry) 1424 and the application processor(s) (or processing circuitry) 1406 are configured to perform the various functions described supra based at least in part of the information stored in the memory (or memory circuitry). That is, the cellular baseband processor(s) (or processing circuitry) 1424 and the application processor(s) (or processing circuitry) 1406 may be configured to perform a first subset of the various functions described supra without information stored in the memory (or memory circuitry) and may be configured to perform a second subset of the various functions described supra based on the information stored in the memory (or memory circuitry). The computer-readable medium/memory (or memory circuitry) may also be used for storing data that is manipulated by the cellular baseband processor(s) (or processing circuitry) 1424/application processor(s) (or processing circuitry) 1406 when executing software. The cellular baseband processor(s) (or processing circuitry) 1424/application processor(s) (or processing circuitry) 1406 may be a component of the UE 450 and may include the at least one memory 460 and/or at least one of the TX processor 468, the RX processor 456, and the controller/processor 459. In one configuration, the apparatus 1404 may be at least one processor chip (modem and/or application) and include just the cellular baseband processor(s) (or processing circuitry) 1424 and/or the application processor(s) (or processing circuitry) 1406, and in another configuration, the apparatus 1404 may be the entire UE (e.g., see UE 450 of FIG. 4) and include the additional modules of the apparatus 1404.

As discussed supra, the component 198 may be configured to receive, from a network entity, a DL WB RS based on an FMCW signal; and report, based on the DL WB RS, an RRM measurement that covers one or more sub-bands within one or more widebands of the FMCW signal. The component 198 may be further configured to perform any of the aspects described in connection with the flowcharts in FIG. 10 and FIG. 11, and/or performed by the UE 902 in FIG. 9. The component 198 may be within the cellular baseband processor(s) (or processing circuitry) 1424, the application processor(s) (or processing circuitry) 1406, or both the cellular baseband processor(s) (or processing circuitry) 1424 and the application processor(s) (or processing circuitry) 1406. The component 198 may be one or more hardware components specifically configured to carry out the stated processes/algorithm, implemented by one or more processors (or processing circuitry) configured to perform the stated processes/algorithm, stored within a computer-readable medium for implementation by one or more processors (or processing circuitry), or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) (or processing circuitry) 1424 and/or the application processor(s) (or processing circuitry) 1406, includes means for receiving, from a network entity, a DL WB RS based on an FMCW signal, and means for reporting, based on the DL WB RS, an RRM measurement that covers one or more sub-bands within one or more widebands of the FMCW signal. The apparatus 1404 may further include means for performing any of the aspects described in connection with the flowcharts in FIG. 10 and FIG. 11, and/or aspects performed by the UE 902 in FIG. 9. The means may be the component 198 of the apparatus 1404 configured to perform the functions recited by the means. As described supra, the apparatus 1404 may include the TX processor 468, the RX processor 456, and the controller/processor 459. As such, in one configuration, the means may be the TX processor 468, the RX processor 456, and/or the controller/processor 459 configured to perform the functions recited by the means.

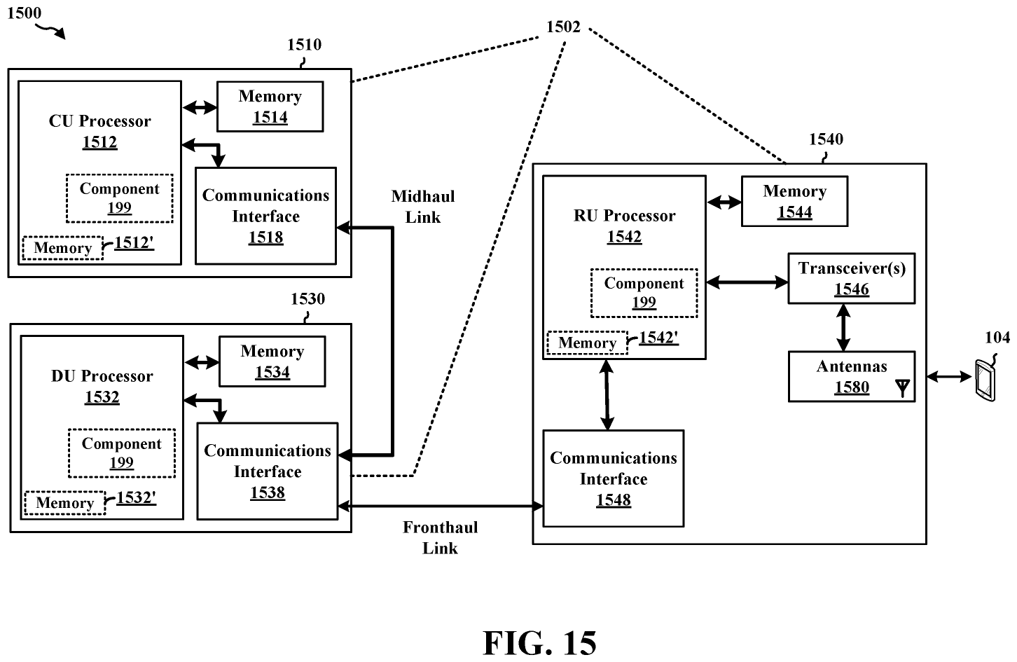

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor (or processing circuitry) 1512. The CU processor(s) (or processing circuitry) 1512 may include on-chip memory (or memory circuitry) 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor (or processing circuitry) 1532. The DU processor(s) (or processing circuitry) 1532 may include on-chip memory (or memory circuitry) 1532′. In some aspects, the DU 1530 may further include additional memory modules 1534 and a communications interface 1538. The DU 1530 communicates with the RU 1540 through a fronthaul link. The RU 1540 may include at least one RU processor (or processing circuitry) 1542. The RU processor(s) (or processing circuitry) 1542 may include on-chip memory (or memory circuitry) 1542′. In some aspects, the RU 1540 may further include additional memory modules 1544, one or more transceivers 1546, antennas 1580, and a communications interface 1548. The RU 1540 communicates with the UE 104. The on-chip memory (or memory circuitry) 1512′, 1532′. 1542′ and the additional memory modules 1514, 1534, 1544 may each be considered a computer-readable medium/memory (or memory circuitry). Each computer-readable medium/memory (or memory circuitry) may be non-transitory. Each of the processors (or processing circuitry) 1512, 1532, 1542 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to provide a DL WB RS based on an FMCW signal; and obtain, based on the DL WB RS, an RRM measurement of a UE, where the RRM measurement covers one or more sub-bands within a wideband of the FMCW signal. The component 199 may be further configured to perform any of the aspects described in connection with the flowcharts in FIG. 12 and FIG. 13, and/or performed by the base station 904 in FIG. 9. The component 199 may be within one or more processors (or processing circuitry) of one or more of the CU 1510, DU 1530, and the RU 1540. The component 199 may be one or more hardware components specifically configured to carry out the stated processes/algorithm, implemented by one or more processors (or processing circuitry) configured to perform the stated processes/algorithm, stored within a computer-readable medium for implementation by one or more processors (or processing circuitry), or some combination thereof. When multiple processors are implemented, the multiple processors may perform the stated processes/algorithm individually or in combination. The network entity 1502 may include a variety of components configured for various functions. In one configuration, the network entity 1502 includes means for providing a DL WB RS based on an FMCW signal, and means for obtaining, based on the DL WB RS, an RRM measurement of a UE, where the RRM measurement covers one or more sub-bands within a wideband of the FMCW signal. The network entity 1502 may further include means for performing any of the aspects described in connection with the flowcharts in FIG. 12 and FIG. 13, and/or aspects performed by the base station 904 in FIG. 9. The means may be the component 199 of the network entity 1502 configured to perform the functions recited by the means. As described supra, the network entity 1502 may include the TX processor 416, the RX processor 470, and the controller/processor 475. As such, in one configuration, the means may be the TX processor 416, the RX processor 470, and/or the controller/processor 475 configured to perform the functions recited by the means.

This disclosure provides a method for wireless communication at a UE. The method may include receiving, from a network entity, a DL WB RS based on an FMCW signal; and reporting, based on the DL WB RS, an RRM measurement that covers one or more sub-bands within one or more widebands of the FMCW signal. By utilizing an FMCW-based DL WB RS, the methods enable the UE to scan and identify preferred sub-bands across a wideband, accommodating the UE that may not fully support the entire wideband. The methods further support an on-demand FMCW for additional measurements to reduce signaling overhead and power consumption. Hence, the methods optimize the usage of available bandwidth and improve the overall efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory (or memory circuitry) includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method may include receiving, from a network entity, a downlink wideband (DL WB) reference signal (RS) based on a frequency-modulated continuous wave (FMCW) signal; and reporting, based on the DL WB RS, a radio resource management (RRM) measurement that covers one or more sub-bands within one or more widebands of the FMCW signal.

Aspect 2 is the method of aspect 1, wherein the RRM measurement may measure one or more of: the reference signal received power (RSRP) based on the FMCW signal, the reference signal received quality (RSRQ) based on the FMCW signal, or the signal-to-interference-plus-noise ratio (SINR) based on the FMCW signal.

Aspect 3 is the method any of aspects 1 to 2, where the method may further include receiving a synchronization signal block (SSB) measurement timing configuration (SMTC) for the FMCW signal, wherein the FMCW signal is within a time window defined by the SMTC.

Aspect 4 is the method of aspect 3, wherein the FMCW signal may be a first FMCW signal, and the method may further include receiving a second FMCW signal, wherein the second FMCW signal is configured within the time window defined by the SMTC.

Aspect 5 is the method of any of aspects 1 to 2, wherein the RRM measurement may include one or more sub-band measurements respectively corresponding to the one or more sub-bands, and reporting the RRM measurement may include reporting the RRM measurement based on the one or more sub-band measurements.

Aspect 6 is the method of any of aspects 1 to 2, wherein the FMCW signal may include component signals continuously changing within a frequency range from a first frequency to a second frequency, and wherein the component signals may continuously cover a frequency domain from the first frequency to the second frequency.

Aspect 7 is the method of any of aspects 1 to 2, wherein the FMCW signal may be scrambled with a scrambling sequence with at least one of a cell identifier (ID) or a beam ID.

Aspect 8 is the method of aspect 7, wherein the FMCW signal may be scrambled with the scrambling sequence at the time domain or the frequency domain.

Aspect 9 is the method of any of aspects 1 to 2, wherein the method may further include transmitting a WB channel measurement request requesting the FMCW signal, and receiving the DL WB RS may include receiving the DL WB RS in response to the WB channel measurement request.

Aspect 10 is the method of aspect 9, wherein the WB channel measurement request may further include at least one of a cell ID identifying a source network entity or a beam ID identifying a transmitting beam, and receiving the DL WB RS may include receiving the DL WB RS from the source network entity or via the transmitting beam. Aspect 11 is the method of aspect 9, wherein the WB channel measurement request may further include a periodicity, and receiving the DL WB RS may include receiving the DL WB RS periodically based on the periodicity from the WB channel measurement request.

Aspect 12 is the method of any of aspects 1 to 2, wherein receiving the DL WB RS may include receiving the DL WB RS based on an RRM measurement report indicating an event associated with the UE.

Aspect 13 is the method of aspect 12, wherein the event associated with the UE may indicate the change of a UE mobility.

Aspect 14 is the method of any of aspects 1 to 2, wherein the FMCW signal may be punctured with a second DL signal in the frequency domain or a gap in the frequency domain.

Aspect 15 is the method of any of aspects 1 to 2, wherein the network entity may be the first network entity, and receiving the DL WB RS may include receiving the DL WB RS from multiple network entities comprising the first network entity, wherein one sub-band of the one or more sub-bands associated with the FMCW signal may be from each network entity of the multiple network entities.

Aspect 16 is an apparatus for wireless communication at a UE, comprising: a processing system that includes processor circuitry and memory circuitry that stores code and is coupled with the processor circuitry, the processing system configured to cause the UE to perform the method of one or more of Aspects 1-15.

Aspect 17 is an apparatus for wireless communication at a UE, comprising: one or more memories; and one or more processors coupled to the one or more memories and, based at least in part on information stored in the one or more memories, the one or more processors, individually or in any combination, are configured to cause the UE to perform the method of any of aspects 1-15.

Aspect 18 is the apparatus for wireless communication at a UE, comprising means for performing the method of any of aspects 1-15.

Aspect 19 is an apparatus of any of aspects 16-18, further comprising one or more transceivers or one or more antennas configured to receive or to transmit in association with the method of any of aspects 1-15.

Aspect 20 is a computer-readable storage medium (e.g., a non-transitory computer-readable medium) storing computer executable code at a UE, the code when executed by at least one processor causes the UE to perform the method of any of aspects 1-15.

Aspect 21 is a method of wireless communication at a network entity. The method may include providing a downlink wideband (DL WB) reference signal (RS) based on a frequency-modulated continuous wave (FMCW) signal; and obtaining, based on the DL WB RS, a radio resource management (RRM) measurement of a user equipment (UE), wherein the RRM measurement covers one or more sub-bands within a wideband of the FMCW signal.

Aspect 22 is the method of aspect 21, where the RRM measurement may measure one or more of the reference signal received power (RSRP) based on the FMCW signal, the reference signal received quality (RSRQ) based on the FMCW signal, or the signal-to-interference-plus-noise ratio (SINR) based on the FMCW signal.

Aspect 23 is the method of any of aspects 21 to 22, wherein the method may further include providing a synchronization signal block (SSB) measurement timing configuration (SMTC) for the UE to measure the FMCW signal, wherein the FMCW signal is within a time window defined by the SMTC.

Aspect 24 is the method of aspect 23, wherein the FMCW signal may be a first FMCW signal, and the method may further include providing a second FMCW signal, wherein the second FMCW signal may be configured within the time window defined by the SMTC.

Aspect 25 is the method of any of aspects 21 to 22, wherein the RRM measurement may include one or more sub-band measurements respectively corresponding to the one or more sub-bands, and obtaining the RRM measurement may include obtaining the RRM measurement based on the one or more sub-band measurements.

Aspect 26 is the method of any of aspects 21 to 22, wherein the FMCW signal may include component signals continuously changing within a frequency range from the first frequency to the second frequency, and wherein the component signals may continuously cover the frequency domain from the first frequency to the second frequency.

Aspect 27 is the method of any of aspects 21 to 22, wherein the FMCW signal may be scrambled with a scrambling sequence with at least one of a cell identifier (ID) or a beam ID.

Aspect 28 is the method of aspect 27, wherein the FMCW signal may be scrambled with the scrambling sequence at the time domain or the frequency domain.

Aspect 29 is the method of any of aspects 21 to 22, wherein the method may further include obtaining a WB channel measurement request requesting the FMCW signal, and providing the DL WB RS may include providing the DL WB RS in response to the WB channel measurement request.

Aspect 30 is the method of aspect 29, wherein the WB channel measurement request may further include a cell ID identifying a source network entity, and providing the DL WB RS may include providing the DL WB RS in response to the cell ID matching the cell ID of the network entity.

Aspect 31 is the method of aspect 29, wherein the WB channel measurement request may further include a periodicity or a beam ID identifying a transmitting beam, and providing the DL WB RS may include providing the DL WB RS periodically based on the periodicity or providing the DL WB RS using the transmitting beam.

Aspect 32 is an apparatus for wireless communication at a network entity, comprising: a processing system that includes processor circuitry and memory circuitry that stores code and is coupled with the processor circuitry, the processing system configured to cause the network entity to perform the method of one or more of Aspects 21-31.

Aspect 33 is an apparatus for wireless communication at a network entity, comprising: one or more memories; and one or more processors coupled to the one or more memories and, based at least in part on information stored in the one or more memories, the one or more processors, individually or in any combination, are configured to cause the network entity to perform the method of any of aspects 21-31.

Aspect 34 is the apparatus for wireless communication at a network entity, comprising means for performing the method of any of aspects 21-31.

Aspect 35 is an apparatus of any of aspects 32-34, further comprising one or more transceivers or one or more antennas configured to receive or to transmit or receive in association with the method of any of aspects 21-31.

Aspect 36 is a computer-readable storage medium (e.g., a non-transitory computer-readable medium) storing computer executable code at a network entity, the code when executed by at least one processor causes the network entity to perform the method of any of aspects 21-31.

What is claimed is:

1. An apparatus for wireless communication at a user equipment (UE), comprising:
one or more memories; and
one or more processors coupled to the one or more memories and, based at least in part on information stored in the one or more memories, the one or more processors, individually or in any combination, are configured to cause the UE to:
receive, from a network entity, a downlink wideband (DL WB) reference signal (RS) based on a frequency-modulated continuous wave (FMCW) signal; and
report, based on the DL WB RS, a radio resource management (RRM) measurement that covers one or more sub-bands within one or more widebands of the FMCW signal.

2. The apparatus of claim 1, wherein the apparatus further comprising:
one or more antennas coupled to the one or more processors, wherein the RRM measurement measures one or more of:
a reference signal received power (RSRP) based on the FMCW signal,
a reference signal received quality (RSRQ) based on the FMCW signal, or
a signal-to-interference-plus-noise ratio (SINR) based on the FMCW signal.

3. The apparatus of claim 2, wherein the one or more processors, individually or in any combination, are further configured to cause the UE to:
receive a synchronization signal block (SSB) measurement timing configuration (SMTC) for the FMCW signal, wherein the FMCW signal is within a time window defined by the SMTC.

4. The apparatus of claim 3, wherein the FMCW signal is a first FMCW signal, and the one or more processors, individually or in any combination, are further configured to cause the UE to:
receive a second FMCW signal, wherein the second FMCW signal is configured within the time window defined by the SMTC.

5. The apparatus of claim 2, wherein the RRM measurement includes one or more sub-band measurements respectively corresponding to the one or more sub-bands, and to report the RRM measurement, the one or more processors, individually or in any combination, are configured to cause the UE to:
report the RRM measurement based on the one or more sub-band measurements.

6. The apparatus of claim 2, wherein the FMCW signal comprises component signals continuously changing within a frequency range from a first frequency to a second frequency, and wherein the component signals continuously cover a frequency domain from the first frequency to the second frequency.

7. The apparatus of claim 2, wherein the FMCW signal is scrambled with a scrambling sequence with at least one of a cell identifier (ID) or a beam ID.

8. The apparatus of claim 7, wherein the FMCW signal is scrambled with the scrambling sequence at a time domain or a frequency domain.

9. The apparatus of claim 2, wherein the one or more processors, individually or in any combination, are further configured to cause the UE to:
transmit a WB channel measurement request requesting the FMCW signal, and wherein, to receive the DL WB RS, the one or more processors, individually or in any combination, are configured to:
receive the DL WB RS in response to the WB channel measurement request.

10. The apparatus of claim 9, wherein the WB channel measurement request further comprises at least one of a cell ID identifying a source network entity or a beam ID identifying a transmitting beam, and, to receive the DL WB RS, the one or more processors, individually or in combination, are configured to cause the UE to:
receive the DL WB RS from the source network entity or via the transmitting beam.

11. The apparatus of claim 9, wherein the WB channel measurement request further includes a periodicity, and to receive the DL WB RS, the one or more processors, individually or in any combination, are configured to cause the UE to:
receive the DL WB RS periodically based on the periodicity from the WB channel measurement request.

12. The apparatus of claim 2, wherein to receive the DL WB RS, the one or more processors, individually or in any combination, are configured to cause the UE to:
receive the DL WB RS based on an RRM measurement report indicating an event associated with the UE.

13. The apparatus of claim 12, wherein the event associated with the UE indicates a change of a UE mobility.

14. The apparatus of claim 2, wherein the FMCW signal is punctured with a second DL signal in a frequency domain or a gap in the frequency domain.

15. The apparatus of claim 2, wherein the network entity is a first network entity, and to receive the DL WB RS, the one or more processors, individually or in any combination, are configured to cause the UE to:
receive the DL WB RS from multiple network entities comprising the first network entity, wherein one sub-band of the one or more sub-bands associated with the FMCW signal is from each network entity of the multiple network entities.

16. An apparatus for wireless communication at a network entity, comprising:
one or more memories; and
one or more processors coupled to the one or more memories and, based at least in part on information stored in the one or more memories, the one or more processors, individually or in any combination, are configured to cause the network entity to:
provide a downlink wideband (DL WB) reference signal (RS) based on a frequency-modulated continuous wave (FMCW) signal; and
obtain, based on the DL WB RS, a radio resource management (RRM) measurement of a user equipment (UE), wherein the RRM measurement covers one or more sub-bands within a wideband of the FMCW signal.

17. The apparatus of claim 16, wherein the RRM measurement measures one or more of:
a reference signal received power (RSRP) based on the FMCW signal,
a reference signal received quality (RSRQ) based on the FMCW signal, or
a signal-to-interference-plus-noise ratio (SINR) based on the FMCW signal.

18. The apparatus of claim 17, further comprising: one or more antennas coupled to the one or more processors, wherein the one or more processors, individually or in any combination, are further configured to cause the network entity to:
provide a synchronization signal block (SSB) measurement timing configuration (SMTC) for the UE to measure the FMCW signal, wherein the FMCW signal is within a time window defined by the SMTC.

19. The apparatus of claim 18, wherein the FMCW signal is a first FMCW signal, and the one or more processors, individually or in any combination, are further configured to cause the network entity to:
provide a second FMCW signal, wherein the second FMCW signal is configured within the time window defined by the SMTC.

20. The apparatus of claim 17, wherein the RRM measurement includes one or more sub-band measurements respectively corresponding to the one or more sub-bands, and to obtain the RRM measurement, the one or more processors, individually or in any combination, are configured to cause the network entity to:
obtain the RRM measurement based on the one or more sub-band measurements.

21. The apparatus of claim 17, wherein the FMCW signal comprises component signals continuously changing within a frequency range from a first frequency to a second frequency, and wherein the component signals continuously cover a frequency domain from the first frequency to the second frequency.

22. The apparatus of claim 17, wherein the FMCW signal is scrambled with a scrambling sequence with at least one of a cell identifier (ID) or a beam ID.

23. The apparatus of claim 22, wherein the FMCW signal is scrambled with the scrambling sequence at a time domain or a frequency domain.

24. The apparatus of claim 17, wherein the one or more processors, individually or in any combination, are further configured to cause the network entity to:
obtain a WB channel measurement request requesting the FMCW signal, and to provide the DL WB RS, the one or more processors, individually or in any combination, are configured to cause the network entity to:
provide the DL WB RS in response to the WB channel measurement request.

25. The apparatus of claim 24, wherein the WB channel measurement request further comprises a cell ID identifying a source network entity, and to provide the DL WB RS, the one or more processors, individually or in any combination, are configured to cause the network entity to:
provide the DL WB RS in response to the cell ID matching the cell ID of the network entity.

26. The apparatus of claim 24, wherein the WB channel measurement request further includes a periodicity or a beam ID identifying a transmitting beam, and to transmit the DL WB RS, the one or more processors, individually or in any combination, are configured to cause the network entity to:
provide the DL WB RS periodically based on the periodicity, or
provide the DL WB RS using the transmitting beam.

27. A method for wireless communication at a user equipment (UE), comprising:
receiving, from a network entity, a downlink wideband (DL WB) reference signal (RS) based on a frequency-modulated continuous wave (FMCW) signal; and
reporting, based on the DL WB RS, a radio resource management (RRM) measurement that covers one or more sub-bands within one or more widebands of the FMCW signal.

28. The method of claim 27, wherein the RRM measurement measures one or more of:
a reference signal received power (RSRP) based on the FMCW signal,
a reference signal received quality (RSRQ) based on the FMCW signal, or
a signal-to-interference-plus-noise ratio (SINR) based on the FMCW signal.

29. The method of claim 28, further comprising:
receiving a synchronization signal block (SSB) measurement timing configuration (SMTC) for the FMCW signal, wherein the FMCW signal is within a time window defined by the SMTC.

30. A method for wireless communication at a network entity, comprising:
providing a downlink wideband (DL WB) reference signal (RS) based on a frequency-modulated continuous wave (FMCW) signal; and
obtaining, based on the DL WB RS, a radio resource management (RRM) measurement of a user equipment (UE), wherein the RRM measurement covers one or more sub-bands within a wideband of the FMCW signal.
